(19) United States
(12) Patent Application Publication
(10) Pub. No.: US 2023/0327962 A1
(43) Pub. Date: Oct. 12, 2023

(54) SYSTEM AND METHOD FOR AUTOMATED SERVICE LEVEL AGREEMENT COMPOSITION FOR INTERNET OF THINGS DEPLOYMENTS

(71) Applicant: Telefonaktiebolaget LM Ericsson (publ), Stockholm (SE)

(72) Inventors: Ajay KATTEPUR, Bangalore (IN); Karthik R M, Chennai (IN); Anubhav GULERIA, New Delhi (IN)

(21) Appl. No.: 18/042,044

(22) PCT Filed: Sep. 1, 2020
(86) PCT No.: PCT/IN2020/050762

§ 371 Date: Feb. 17, 2023

(51) Int. Cl. H04L 41/5006; H04L 43/08; H04L 41/5009; H04L 41/5022; H04W 28/02; H04W 28/24

(52) U.S. Cl. CPC H04L 41/5006; H04L 43/08; H04L 41/5009; H04L 41/5022; H04W 28/0268; H04W 28/24

(57) ABSTRACT

According to one or more embodiments, a node is provided where the node is configured to: transform a plurality of service level agreement, SLA, values into a plurality of uniform language values associated with at least a first quality of service, QoS, composite metric, and optionally generate a first end-to-end composite SLA based at least on a first set of the plurality of uniform language values.

### TECHNICAL FIELD

Wireless communication and in particular, dynamic service level agreement (SLA) composition.

### BACKGROUND

Large scale Internet of Things (IoT) deployments such as those described in Industry 4.0 Factories (i.e., deployment guidelines) include compositions of multiple heterogeneous devices such as sensor-actuators, data sources, edge/cloud computation resources, networking infrastructures, etc. In order to help ensure end-to-end guarantees such as throughput, accessibility, latency, etc., to users/devices of IoT systems, Service Level Agreements (SLAs) may be implemented. Each SLA may be individual in nature where there is a one-to-one agreement between entities and one of the entities agrees/guarantees one or more SLA specifications. Entities participating in SLAs include the devices, service providers and (sub-contracted) third party vendors.

Typically, the mechanism for establishing SLAs is a protracted one, involving rounds of negotiation and identification of liabilities in case of failures to meet agreements/SLA specifications. This process is compounded in large scale Internet of Things (IoT) deployments, where facilities are sub-contracted to multiple third-party vendors. Some approaches for SLA management have been proposed for web service/cloud. However, there are problems in extending the current formulation into the management of IoT SLAs. The timing constraints seen for IoT are not captured in web services. Moreover, no global view is possible in IoT (unlike cloud datacenters) as various third party providers individually manage services. Also, transforming non-traditional IoT QoS metrics for SLA management is another problem.

To determine how each data analysis activity consistently achieves its QoS objectives defined in the SLA(s) while dynamically handling the run-time uncertainties of data flow behavior and “Cloud-Edge-Things” performance is an unsolved problem. Further, the QoS prediction models are not dynamically tunable based on real-time monitoring information available from holistic monitoring approaches.

The use of temporal planning to generate web services compositions/QoS selections is implemented in existing systems. However, the temporal plans are specific to optimization/scheduling of workflows and do not consider the hierarchy of IoT layers with contingencies built-in. Further, every layer of the IoT deployments (sensing, actuation, network slice, compute, application) has a unique SLA model that is neither straightforward to map nor compare/compose, thereby further complicating SLA management in IoT. Hence, the use of SLAs in IoT suffers from various problems.

### SUMMARY

Some embodiments advantageously provide a method, system and other arrangements for dynamic service level agreement (SLA) composition.

One or more embodiments provide for automated SLA contracts for IoT that may use one or more of the following:
Representation of SLA components exposed by the vendors/service providers/end users that can be dynamically composed by AI planners given a high level SLA.
Transformation of non-traditional QoS metrics from IoT and network slicing into a standard format to allow for the dynamic composition of SLA components.
Automated contingency planning of SLA reconfiguration to prevent deterioration in performance. The automated contingency planning of SLA reconfiguration may make use of “fine-grained” SLA contracts—shorter time instances and quicker resolutions of deviations.

According to one aspect of the disclosure, a node is provided where the node is configured to: transform a plurality of service level agreement, SLA, values into a plurality of uniform language values associated with at least a first quality of service, QoS, composite metric; and optionally generate a first end-to-end composite SLA based at least on a first set of the plurality of uniform language values.

According to one or more embodiments of this aspect, the node is further configured to receive at least one predefined criterion including a maximum first QoS composite metric value where the generating of the first end-to-end composite SLA is based on the maximum first QoS composite metric value. According to one or more embodiments of this aspect, the node is further configured to monitor operational data associated with the first end-to-end composite SLA; determine that the operational data fails to meet the at least one predefined criterion in a predefined quantity of instances; and generate a second end-to-end composite SLA based at least on the determination that the operational data fails to meet the at least one predefined criterion in the predefined quantity of instances where the second end-to-end composite SLA is based at least on a second set of the plurality of uniform language values. According to one or more embodiments of this aspect, the plurality of uniform language values are associated with a second QoS composite metric that is different from the first QoS composite metric; and one of: the first QoS composite metric is prioritized over the second QoS composite metric for generating an end-to-end composite SLA; and the second QoS composite metric is prioritized over the first QoS composite metric for generating an end-to-end composite SLA.

According to one or more embodiments of this aspect, the second QoS composite metric is a cost metric. According to one or more embodiments of this aspect, the at least one predefined criterion includes a maximum second QoS composite metric value where the generating of the first end-to-end SLA is based on the maximum second QoS composite metric value of the at least one predefined criterion. According to one or more embodiments of this aspect, the network node is further configured to monitor operational data associated with the first end-to-end composite SLA; determine the operational data fails to meet the at least one predefined criterion in a predefined quantity of instances; and generate a second end-to-end composite SLA based at least on the determination that the operational data fails to meet the at least one predefined criterion in the predefined quantity of instances where the second end-to-end composite SLA is based at least on the second set of the plurality of uniform language values.

According to one or more embodiments of this aspect, the second end-to-end composite SLA is associated with at least one different service vendor than the first end-to-end composite SLA. According to one or more embodiments of this aspect, the second end-to-end composite SLA corresponds to a plurality of predefined SLAs, each predefined SLA configured to provide a network service according to a respective service value. According to one or more embodiments of this aspect, the second end-to-end composite SLA is configured to provide one of: less latency deviation than the first end-to-end composite SLA; a larger network slice than the first end-to-end composite SLA; and addition network resources than the first end-to-end composite SLA.

According to one or more embodiments of this aspect, one of: the second set of the plurality of uniform language values meets the at least one predefined criterion; and the second set of the plurality of uniform language values meets a modified version of the at least one predefined criterion where the modified version of the at least one predefined criterion is configured due to the plurality of uniform language values being unable to meet the at least one predefined criterion. According to one or more embodiments of this aspect, the at least one predefined criterion is provided by a user of the first end-to-end composite SLA. According to one or more embodiments of this aspect, the node is further configured to: identify a plurality of SLA tiers, each SLA tier including at least one of the plurality of SLA values; and the generating of the first end-to-end composite SLA being based on selecting uniform language values corresponding to each one of the plurality of SLA tiers to form the first set of the plurality of uniform language values. According to one or more embodiments of this aspect, the plurality of SLA tiers includes one of a first tier associated with a network slice from a wireless device to a network node, a second tier associated with a network slice from the network node to an edge network node, and a third tier associated with a cloud network computing network node.

According to another aspect of the disclosure, a method implemented by a node is provided. A plurality of service level agreement, SLA, values are transformed into a plurality of uniform language values associated with at least a first quality of service, QoS, composite metric. A first end-to-end composite SLA is optionally generated based at least on a first set of the plurality of uniform language values.

According to one or more embodiments of this aspect, receiving at least one predefined criterion including a maximum first QoS composite metric value is received where the generating of the first end-to-end composite SLA is based on the maximum first QoS composite metric value. According to one or more embodiments of this aspect, operational data associated with the first end-to-end composite SLA is monitored. A determination is made that the operational data fails to meet the at least one predefined criterion in a predefined quantity of instances. A second end-to-end composite SLA is generated based at least on the determination that the operational data fails to meet the at least one predefined criterion in the predefined quantity of instances where the second end-to-end composite SLA is based at least on a second set of the plurality of uniform language values.

According to one or more embodiments of this aspect, the plurality of uniform language values are associated with a second QoS composite metric that is different from the first QoS composite metric. One of the first QoS composite metric is prioritized over the second QoS composite metric for generating an end-to-end composite SLA, and the second QoS composite metric is prioritized over the first QoS composite metric for generating an end-to-end composite SLA. According to one or more embodiments of this aspect, the second QoS composite metric is a cost metric. According to one or more embodiments of this aspect, the at least one predefined criterion includes a maximum second QoS composite metric value where the generating of the first end-to-end SLA is based on the maximum second QoS composite metric value of the at least one predefined criterion.

According to one or more embodiments of this aspect, operational data associated with the first end-to-end composite SLA is monitored. The operational data is determined to fail to meet the at least one predefined criterion in a predefined quantity of instances. A second end-to-end composite SLA is generated based at least on the determination that the operational data fails to meet the at least one predefined criterion in the predefined quantity of instances where the second end-to-end composite SLA is based at least on the second set of the plurality of uniform language values. According to one or more embodiments of this aspect, the second end-to-end composite SLA is associated with at least one different service vendor than the first end-to-end composite SLA. According to one or more embodiments of this aspect, the second end-to-end composite SLA corresponds to a plurality of predefined SLAs, each predefined SLA configured to provide a network service according to a respective service value.

According to one or more embodiments of this aspect, the second end-to-end composite SLA is configured to provide one of: less latency deviation than the first end-to-end composite SLA; a larger network slice than the first end-to-end composite SLA; and addition network resources than the first end-to-end composite SLA. According to one or more embodiments of this aspect, one of: the second set of the plurality of uniform language values meets the at least one predefined criterion; and the second set of the plurality of uniform language values meets a modified version of the at least one predefined criterion where the modified version of the at least one predefined criterion is configured due to the plurality of uniform language values being unable to meet the at least one predefined criterion. According to one or more embodiments of this aspect, the at least one predefined criterion is provided by a user of the first end-to-end composite SLA.

According to one or more embodiments of this aspect, identifying a plurality of SLA tiers are identified where each SLA tier includes at least one of the plurality of SLA values, and the generating of the first end-to-end composite SLA being based on selecting uniform language values corresponding to each one of the plurality of SLA tiers to form the first set of the plurality of uniform language values. According to one or more embodiments of this aspect, the plurality of SLA tiers includes one of a first tier associated with a network slice from a wireless device to a network node, a second tier associated with a network slice from the network node to an edge network node, and a third tier associated with a cloud network computing network node.

### BRIEF DESCRIPTION OF THE DRAWINGS

A more complete understanding of the present embodiments, and the attendant advantages and features thereof, will be more readily understood by reference to the following detailed description when considered in conjunction with the accompanying drawings wherein:

FIG. 1 is a schematic diagram of an exemplary network architecture illustrating a communication system according to the principles in the present disclosure;

FIG. 2 is a block diagram of a node according to some embodiments of the present disclosure;

FIG. 3 is a flowchart of an exemplary process in a node according to some embodiments of the present disclosure;

FIG. 4 is a block diagram of an Industry 4.0 scenario;

FIG. 5 is a diagram of a lifecycle of a service level agreement in a multi-provider environment;

FIG. 6 is a diagram of a SLA negotiation service chain;

FIG. 7a is a graph of an example of a contingency planning output according to some embodiments of the present disclosure;

FIG. 7b is a graph of an example of a contingency planning output according to some embodiments of the present disclosure;

FIG. 7c is a graph of an example of a contingency planning output according to some embodiments of the present disclosure;

FIG. 7d is a graph of an example of a contingency planning output according to some embodiments of the present disclosure;

FIG. 8 is a sequence diagram according to some embodiments of the present disclosure;

FIG. 9 is an example cloud implementation according to some embodiments of the present disclosure; and

FIG. 10 is a table of example parameters according to some embodiments of the present disclosure.

### DETAILED DESCRIPTION

The teachings described herein solve one or more problems associated with existing systems at least in part by composing logical components of an IoT system to meet the required SLA specifications/constraints. This may be performed through translation of multiple sensing, actuation, network slice and compute node layers. The SLAs are specified with temporal durations, pre-conditions and effects, allowing for node to implement AI based re-planning and restructuring due to changes. Several aspects of this process are as follows:
1. The translation of IoT-centric QoS parameters (e.g., sensing, actuation rate, etc.) to standard QoS (e.g., latency, throughput, cost, etc.);
2. Translating network slice-centric QoS parameters to standard format or standard QoS for composition.
3. Modeling the precondition and effects of composing actions on the QoS in PDDL-type modeling to enable AI based reconfigurations.

Further, in order to meet the SLA specifications, one or more embodiments of the disclosure provide automated tools and techniques for composing, generating and/or modifying the end-to-end components of a SLA. This may require a uniform set of rules and/or parameters to transform, compose and sub-contract components participating in IoT deployments, as described herein. Further, the unified model using the uniform set of rules and/or parameters may be extended to a hierarchy of IoT layers with contingencies built-in. This, unified model may be used for transformation and QoS composition across tiers/IoT layers, which may be performed in a dynamic manner and the composition of the SLA may occur automatically in a planned fashion.

Before describing in detail exemplary embodiments, it is noted that the embodiments reside primarily in combinations of apparatus components and processing steps related to dynamic SLA composition. Accordingly, components have been represented where appropriate by conventional symbols in the drawings, showing only those specific details that are pertinent to understanding the embodiments so as not to obscure the disclosure with details that will be readily apparent to those of ordinary skill in the art having the benefit of the description herein. Like numbers refer to like elements throughout the description.

As used herein, relational terms, such as “first” and “second,” “top” and “bottom,” and the like, may be used solely to distinguish one entity or element from another entity or element without necessarily requiring or implying any physical or logical relationship or order between such entities or elements. The terminology used herein is for the purpose of describing particular embodiments only and is not intended to be limiting of the concepts described herein. As used herein, the singular forms “a”, “an” and “the” are intended to include the plural forms as well, unless the context clearly indicates otherwise. It will be further understood that the terms “comprises,” “comprising,” “includes” and/or “including” when used herein, specify the presence of stated features, integers, steps, operations, elements, and/or components, but do not preclude the presence or addition of one or more other features, integers, steps, operations, elements, components, and/or groups thereof.

In embodiments described herein, the joining term, “in communication with” and the like, may be used to indicate electrical or data communication, which may be accomplished by physical contact, induction, electromagnetic radiation, radio signaling, infrared signaling or optical signaling, for example. One having ordinary skill in the art will appreciate that multiple components may interoperate and modifications and variations are possible of achieving the electrical and data communication.

In some embodiments described herein, the term “coupled,” “connected,” and the like, may be used herein to indicate a connection, although not necessarily directly, and may include wired and/or wireless connections.

The term “network node” used herein can be any kind of network node comprised in a radio network which may further comprise any of base station (BS), radio base station, base transceiver station (BTS), base station controller (BSC), radio network controller (RNC), g Node B (gNB), evolved Node B (eNB or eNodeB), Node B, multi-standard radio (MSR) radio node such as MSR BS, multi-cell/multicast coordination entity (MCE), integrated access and backhaul (IAB) node, relay node, donor node controlling relay, radio access point (AP), transmission points, transmission nodes, Remote Radio Unit (RRU) Remote Radio Head (RRH), a core network node (e.g., mobile management entity (MME), self-organizing network (SON) node, a coordinating node, positioning node, MDT node, etc.), an external node (e.g., 3rd party node, a node external to the current network), nodes in distributed antenna system (DAS), a spectrum access system (SAS) node, an element management system (EMS), etc. The network node may also comprise test equipment. The term “radio node” used herein may be used to also denote a wireless device (WD) such as a wireless device (WD) or a radio network node.

In some embodiments, the non-limiting terms wireless device (WD) or a user equipment (UE) are used interchangeably. The WD herein can be any type of wireless device capable of communicating with a network node or another WD over radio signals, such as wireless device (WD). The WD may also be a radio communication device, target device, device to device (D2D) WD, machine type WD or WD capable of machine to machine communication (M2M), low-cost and/or low-complexity WD, a sensor equipped with WD, Tablet, mobile terminals, smart phone, laptop embedded equipped (LEE), laptop mounted equipment (LME), USB dongles, Customer Premises Equipment (CPE), an Internet of Things (IoT) device, or a Narrowband IoT (NB-IOT) device, etc.

Also, in some embodiments the generic term “radio network node” is used. It can be any kind of a radio network node which may comprise any of base station, radio base station, base transceiver station, base station controller, network controller, RNC, evolved Node B (eNB), Node B, gNB, Multi-cell/multicast Coordination Entity (MCE), IAB node, relay node, access point, radio access point, Remote Radio Unit (RRU) Remote Radio Head (RRH).

Note that although terminology from one particular wireless system, such as, for example, 3GPP LTE and/or New Radio (NR) that may be providing Internet of Things (IoT) functionality, may be used in this disclosure, this should not be seen as limiting the scope of the disclosure to only the aforementioned system. Other wireless systems, including without limitation Wide Band Code Division Multiple Access (WCDMA), Worldwide Interoperability for Microwave Access (WiMax), Ultra Mobile Broadband (UMB) and Global System for Mobile Communications (GSM), may also benefit from exploiting the ideas covered within this disclosure.

Note further, that functions described herein as being performed by a node may be distributed over a plurality of nodes. In other words, it is contemplated that the functions of the node described herein are not limited to performance by a single physical device and, in fact, can be distributed among several physical devices.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

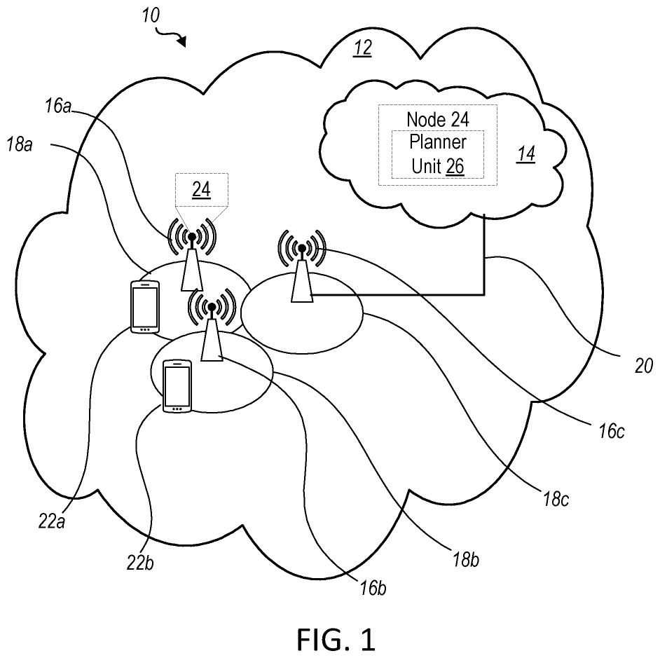

Some embodiments provide dynamic SLA composition. Referring now to the drawing figures, in which like elements are referred to by like reference numerals, there is shown in FIG. 1 a schematic diagram of a communication system 10, according to an embodiment, such as a 3GPP-type cellular network that may support standards such as LTE and/or NR (5G) and may be providing IoT functionality, which comprises an access network 12, such as a radio access network, and a core network 14. The access network 12 comprises a plurality of network nodes 16a, 16b, 16c (referred to collectively as network nodes 16), such as NBs, eNBs, gNBs or other types of wireless access points, each defining a corresponding coverage area 18a, 18b, 18c (referred to collectively as coverage areas 18). Each network node 16a, 16b, 16c is connectable to the core network 14 over a wired or wireless connection 20. A first wireless device (WD) 22a located in coverage area 18a is configured to wirelessly connect to, or be paged by, the corresponding network node 16a. A second WD 22b in coverage area 18b is wirelessly connectable to the corresponding network node 16b. While a plurality of WDs 22a, 22b (collectively referred to as wireless devices 22) are illustrated in this example, the disclosed embodiments are equally applicable to a situation where a sole WD is in the coverage area or where a sole WD is connecting to the corresponding network node 16. Note that although only two WDs 22 and three network nodes 16 are shown for convenience, the communication system may include many more WDs 22 and network nodes 16. In one or more embodiments, WD 22 is a IoT device.

Also, it is contemplated that a WD 22 can be in simultaneous communication and/or configured to separately communicate with more than one network node 16 and more than one type of network node 16. For example, a WD 22 can have dual connectivity with a network node 16 that supports LTE and the same or a different network node 16 that supports NR. As an example, WD 22 can be in communication with an eNB for LTE/E-UTRAN and a gNB for NR/NG-RAN.

Core network 14 may include one or more nodes 24 that is configured to perform one or more functions as described herein such as with respect to dynamic SLA composition.

A node 24 is configured to include planner unit 26 which is configured to perform one or more node 24 functions as described herein such as with respect to dynamic SLA composition. In an alternative embodiment, the functionality of node 24 may be performed by network node 16 such as if network node 16 is configured to include a planner unit 26 which is configured to perform one or more functions as described herein such as with respect to dynamic SLA composition.

Further, system 10 may be associated with one or more vendors such as network slice vendor(s), compute vendor(s), etc., that operate one or more services and/or one or more entities in system 10.

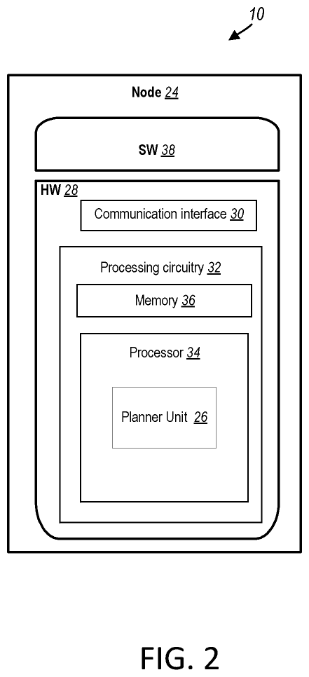

Example implementations, in accordance with an embodiment, of the node 24 discussed in the preceding paragraphs will now be described with reference to FIG. 2. Node 24 includes hardware 28 enabling it to communicate with one or more entities in system 10. The hardware 28 may include a communication interface 30 for setting up and maintaining a wired or wireless connection with an interface of a different communication device/entity of the communication system 10.

In the embodiment shown, the hardware 28 of the node 24 further includes processing circuitry 32. The processing circuitry 32 may include a processor 34 and a memory 36. In particular, in addition to or instead of a processor, such as a central processing unit, and memory, the processing circuitry 32 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 34 may be configured to access (e.g., write to and/or read from) the memory 36, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Thus, the node 24 further has software 38 stored internally in, for example, memory 36, or stored in external memory (e.g., database, storage array, network storage device, etc.) accessible by the network node 16 via an external connection. The software 38 may be executable by the processing circuitry 32. The processing circuitry 32 may be configured to control any of the methods and/or processes described herein and/or to cause such methods, and/or processes to be performed, e.g., by node 24. Processor 34 corresponds to one or more processors 34 for performing node 24 functions described herein. The memory 36 is configured to store data, programmatic software code and/or other information described herein. In some embodiments, the software 38 may include instructions that, when executed by the processor 34 and/or processing circuitry 32, causes the processor 34 and/or processing circuitry 32 to perform the processes described herein with respect to node 24. For example, processing circuitry 32 of the node 24 may include planner unit 26 configured to perform one or more node 24 functions as described herein such as with respect to dynamic SLA composition.

In some embodiments, the inner workings of the node 24 may be as shown in FIG. 2 and independently, the surrounding network topology may be that of FIG. 1.

Although FIGS. 1 and 2 show various “units” such as planner units 26 as being within a respective processor, it is contemplated that these units may be implemented such that a portion of the unit is stored in a corresponding memory within the processing circuitry. In other words, the units may be implemented in hardware or in a combination of hardware and software within the processing circuitry.

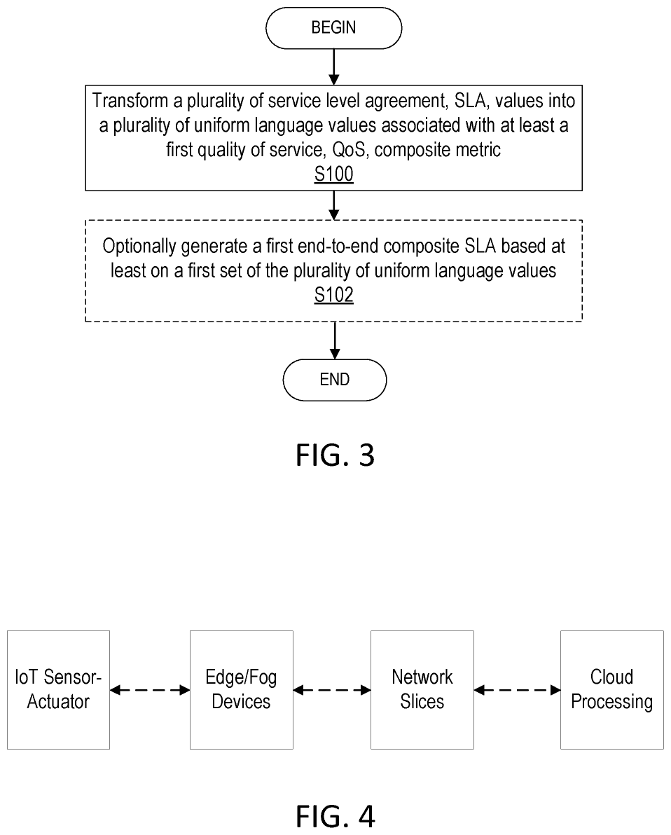

FIG. 3 is a flowchart of an exemplary process according to some embodiments of the disclosure. One or more Blocks and/or functions performed by node 24 may be performed by one or more elements of node 24 such as by planner unit 26 in processing circuitry 32, processor 34, communication interface 30, etc. In one or more embodiments, node 24 such as via one or more of processing circuitry 32, processor 34, planner unit 26 and communication interface 30 is configured to transform (Block S100) a plurality of service level agreement, SLA, values into a plurality of uniform language values associated with at least a first quality of service, QoS, composite metric as described herein. In one or more embodiments, node 24 such as via one or more of processing circuitry 32, processor 34, planner unit 26 and communication interface 30 is configured to optionally generate (Block S102) a first end-to-end composite SLA based at least on a first set of the plurality of uniform language values, as described herein.

According to one or more embodiments, node 24 such as via one or more of processing circuitry 32, processor 34, planner unit 26 and communication interface 30 is configured to receive at least one predefined criterion including a maximum first QoS composite metric value where the generating of the first end-to-end composite SLA is based on the maximum first QoS composite metric value.

According to one or more embodiments, node 24 such as via one or more of processing circuitry 32, processor 34, planner unit 26 and communication interface 30 is configured to monitor operational data associated with the first end-to-end composite SLA; determine that the operational data fails to meet the at least one predefined criterion in a predefined quantity of instances; and generate a second end-to-end composite SLA based at least on the determination that the operational data fails to meet the at least one predefined criterion in the predefined quantity of instances, the second end-to-end composite SLA being based at least on a second set of the plurality of uniform language values. According to one or more embodiments, the plurality of uniform language values are associated with a second QoS composite metric that is different from the first QoS composite metric; and one of: the first QoS composite metric is prioritized over the second QoS composite metric for generating an end-to-end composite SLA; and the second QoS composite metric is prioritized over the first QoS composite metric for generating an end-to-end composite SLA.

According to one or more embodiments, the second QoS composite metric is a cost metric. According to one or more embodiments, the at least one predefined criterion includes a maximum second QoS composite metric value where the generating of the first end-to-end SLA is based on the maximum second QoS composite metric value of the at least one predefined criterion. According to one or more embodiments, node 24 such as via one or more of processing circuitry 32, processor 34, planner unit 26 and communication interface 30 is configured to monitor operational data associated with the first end-to-end composite SLA; determine the operational data fails to meet the at least one predefined criterion in a predefined quantity of instances; and generate a second end-to-end composite SLA based at least on the determination that the operational data fails to meet the at least one predefined criterion in the predefined quantity of instances where the second end-to-end composite SLA is based at least on the second set of the plurality of uniform language values.

According to one or more embodiments, the second end-to-end composite SLA is associated with at least one different service vendor than the first end-to-end composite SLA. According to one or more embodiments, the second end-to-end composite SLA corresponds to a plurality of predefined SLAs where each predefined SLA is configured to provide a network service according to a respective service value. According to one or more embodiments, the second end-to-end composite SLA is configured to provide one of: less latency deviation than the first end-to-end composite SLA; a larger network slice than the first end-to-end composite SLA; and addition network resources than the first end-to-end composite SLA.

According to one or more embodiments, one of: the second set of the plurality of uniform language values meets the at least one predefined criterion; and the second set of the plurality of uniform language values meets a modified version of the at least one predefined criterion where the modified version of the at least one predefined criterion is configured due to the plurality of uniform language values being unable to meet the at least one predefined criterion. According to one or more embodiments, the at least one predefined criterion is provided by a user of the first end-to-end composite SLA. According to one or more embodiments, node 24 such as via one or more of processing circuitry 32, processor 34, planner unit 26 and communication interface 30 is configured to identify a plurality of SLA tiers, each SLA tier including at least one of the plurality of SLA values; and the generating of the first end-to-end composite SLA being based on selecting uniform language values corresponding to each one of the plurality of SLA tiers to form the first set of the plurality of uniform language values. According to one or more embodiments, the plurality of SLA tiers includes one of a first tier associated with a network slice from a wireless device to a network node, a second tier associated with a network slice from the network node to an edge network node, and a third tier associated with a cloud network computing network node.

Having generally described arrangements for dynamic SLA composition, details for these arrangements, functions and processes are provided as follows, and which may be implemented by node 24.

Some embodiments provide dynamic SLA composition, i.e., dynamic generation, composition, modification, etc., of an end-to-end composite SLA.

Industry 4.0 Scenario

For the following description, the link of IoT connected devices, i.e., wireless devices 22, of FIG. 4 is considered on which SLAs are to be composed according to the principles of the disclosure. The specific example is as follows:
Robotic IoT sensor/actuator (an example of a wireless device 22) has an SLA on latency (response between sensing and actuation within a given bound, i.e., an example of an SLA value);
Edge/Cloud Device has an SLA on availability of compute nodes (CPU/Memory capacity, availability, etc., which are examples of SLA values) where edge/cloud device may be a network node 16 in the access network 12 or other entity in the access network 12.
Network Slice has an SLA on throughput (data transmitted within a given time limit which is an example of a SLA value) provided per network slice;
   All of the values (i.e., SLA values) may be traded off against a cost value that may be optimized.

SLA Composition Process

QoS Algebra for Composition

Composition of atomic services, i.e., individual services that are part of an end-to-end SLA, to form more composite services has been studied in the web services community. This has also led to work related to end-to-end quality of service (QoS) composition for a web service. Some of the general QoS metrics may advantageously be applied as described herein for the generation and management of SLAs having multiple IoT tiers/layers. Some examples of these QoS metrics include one or more of:
1. Latency δ—The latency of a service δ (s) measures the delay between the moment a request is sent and when the response is received. This combines δ_{processing} and δ_{transmission} delays. The SLA may be expressed as an aggregate monitoring of all service latencies over a duration, with mean and standard deviation within bounds/limits.
2. Availability α—This availability of a service α(s) measures the probability that a service is available in system 10. It is measured as T_{α} (s)/θ, where T_{α} (s) is the total number of seconds that the service was available over the monitoring period.
3. Throughput λ: This is a number of times a service may be accessed in a particular period. This is related to latency δ using Little's law: N=λ*δ, where N is the number of concurrent transactions.
4. Cost C: The execution cost C(s) is the cost of invoking the service. This may be per-invocation, may be set to a number per hours/days, etc.

Given these QoS metrics (also referred to as QoS composite metrics) in atomic QoS models, a unified QoS composition model is used herein to provide SLA generation and management. An example of the unified QoS composition model is as follows:

q=( [symbol] ,≤,⊕,∧,∨) (1)
1) ( [symbol] , ≤) is a QoS domain with corresponding partially ordered set of QoS values
2) ⊕: [symbol] × [symbol] → [symbol] defines how QoS gets incremented by each new event/operation. It satisfies the following conditions:
   ⊕ possesses a neutral element 0 satisfying ∀q ∈ [symbol] ⇒q ⊕0=0 ⊕q=q.
   ⊕ is monotonic: q₁≤q₁′ and q₂≤q₂′ imply (q₁⊕q₂)≤(q₁′⊕q₂′).
3) (∧, ∨) represent the lower and upper lattice, meaning that any q⊆ [symbol] has a unique least lower, upper bound (∧_{q}, ∨_{q}). When taking the best response with respect to the ordering ≤, the lowest QoS is taken with ∧. When synchronizing events, the operator ∨ amounts to taking the worst QoS as per the ordering ≤.

One example uses a latency δ composition. The partial ordering for latency is (<), meaning less is a superior quality. For a sequential composition, the latency is composed as δ (s1)+δ (s2), where s1 (i€{1,2, . . . , n}) represents individual atomic services. The best response in case of parallel invocation is min(δ (s1), δ (s2)). The synchronization operator is max(δ (s1), δ (s2)) waiting until all services complete.

The latency and/or latency composition can be traded off against cost. The partial ordering for cost is (<), meaning less is a superior quality. Irrespective of the composition process, the cost may be the sum of C(s1), C(s2). The minimum costing service may be selected likewise.

Table 1a provided below illustrates various examples of QoS metrics (i.e., QoS composite metrics), domains and algebra.

TABLE 1a

| Qos Metric | | [symbol] | ≤ | ⊕ | [symbol] | [symbol] |
|---|---|---|---|---|---|---|
| δ: | Latency | [symbol] ₊ | ≤ | + | min | max |
| [symbol] : | Cost | [symbol] [symbol] [symbol] | ⊆ on [symbol] | ∪ | ∩ | ∪ |
| S: | Security | [symbol] | ≥ on [symbol] | [symbol] | max | min |
| Δ: | Data Quality | [symbol] | ≥ on [symbol] | [symbol] | max | min |
| λ: | Throughput | [symbol] ₊ | ≤ | + | min | max |
| α: | Accuracy | [symbol] | ≥ on [symbol] | [symbol] | max | min |
| [symbol] ᵢ: | Msg. Integrity | [symbol] | ≥ on [symbol] | [symbol] | max | min |
| [symbol] ₑ: | Msg. Efficiency | [symbol] | ≥ on [symbol] | [symbol] | max | min |

TABLE 1b
Table 1b below illustrates QoS composition
with business process patterns.

| BPMN Workflow Pattern | Operator |
|---|---|
| Sequence | ⊕ |
| Exclusive Choice - Simple Merge | [symbol] |
| Multi-Choice - Multiple Merge | [symbol] |
| Parallel Split - Synchronization/Discriminator | [symbol] |
| N out of M Join; Cycles/Loops | [symbol] |
| Milestone; Cancel Activity/Case; Termination | [symbol] _{⊥} |

Given a QoS value, a partial ordering and the sequence of actions that are taken, the end-to-end QoS for latency, availability, cost and accuracy can be generated for each of these QoS metrics. These end-to-end QoS metrics may be mapped to BPMN Workflow Patterns, allowing for formal composition of services and QoS.

IoT SLA Transformation Rules

IoT SLA Composition via Transformation Rules

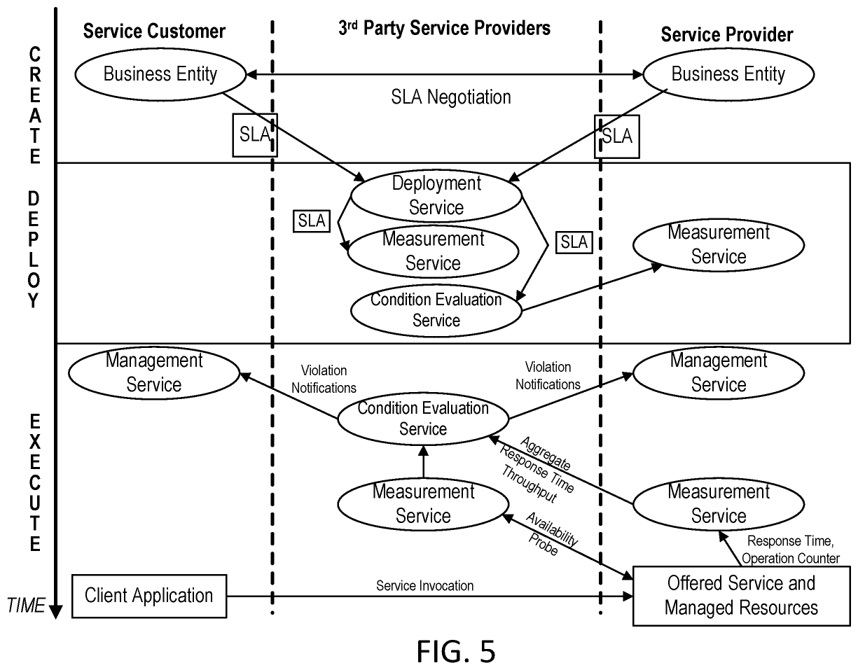

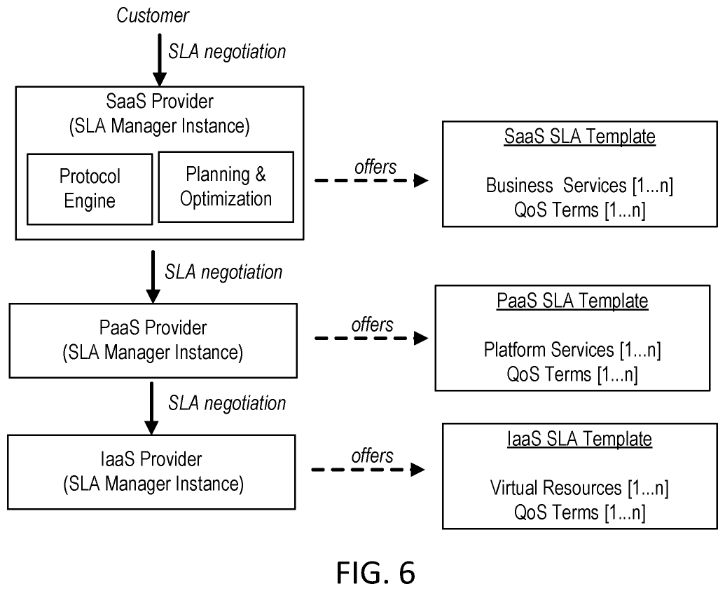

Once the QoS composition model has been defined, the end-to-end SLA composition may be derived for the IoT vendors. The starting point may be to implement web services/XaaS SLA composition models (see A Protocol Development Framework for SLA Negotiations in Cloud and Service Computing, Workflow Composition of Service Level Agreements). FIG. 5 is a diagram of a lifecycle of a SLA in a multi-provider environment. FIG. 6 is a diagram of a SLA negotiation service chain.

The web services/XaaS SLA composition model is advantageously extended to end-to-end SLA composition for IoT, based on the scenario described above such as a scenario that includes various IoT devices. Indeed, while multiple composition models have been provided for a single tier of services, such models can be extended, as described herein, to end-to-end SLA covering sensors, actuators, network slice, edge, cloud infrastructures.

With respect to the QoS metric of latency, Table 2 illustrates latency composition for IoT. In particular, the atomic value associated with latency (X) is transformed to a uniform language value where the SLA composition (i.e., end-to-end composite SLA) is formed/generated/modified based on the uniform language value.

TABLE 2

| | | Transformed SLA | |
|---|---|---|---|
| | | in units of | |
| | Atomic SLA | uniform language | |
| SLA Tier | value | values | SLA Composition |
| IoT Sensor s1 | Sensing rate λ(s1) | Using Little's law, | δ(s1) |
| | at some accuracy | we generate δ(s1) | |
| | | or data driven | |
| | | machine learning | |
| | | model | |
| WD to network | Throughput rate | Using Little's law, | δ(s1) ⊕ δ(s2) |
| node network slice | λ(s2), Latency | we generate δ(s2) | |
| s2 | specification δ(s2) | | |
| Network node to | Throughput rate | Using Little's law, | δ(s1) ⊕ δ(s2) ⊕ |
| edge/cloud | λ(s2), Latency | we generate δ(s3) | δ(s3) |
| network slice s3 | specification δ(s3) | | |
| Edge compute | CPU, Memory | Either using | δ(s1) ⊕ δ(s2) ⊕ |
| Node s4 | availability α(s4) - | Gustafferson's law | δ(s3) ⊕ δ(s4) |
| | larger available | or doing | |
| | resources typically | benchmark | |
| | imply faster | profiling of | |
| | processing | infrastructure, | |
| | | derive computation | |
| | | times: δ(s4) | |
| (Redundant) | CPU, Memory | Profiling to derive | δ(s1) ⊕ δ(s2) ⊕ |
| Cloud Compute | availability α(s5) - | δ(s5) | δ(s3) ⊕ ∧ (δ(s4) |
| Node s5 | larger available | | δ(s5)) |
| | resources typically | | |
| | imply faster | | |
| | processing | | |
| IoT Actuator s6 | Actuation latency | δ(s6) | δ(s1) ⊕ δ(s2) ⊕ |
| | δ(s6) | | δ(s3) ⊕ ∧ (δ(s4) ⊕ |
| | | | δ(s5)) ⊕ δ(s6) |

Once the end-to-end composite SLA is derived, this may be checked against the SLA requirements (i.e., predefined criterion/criteria) to check if they are met. While this represents one data point instance being checked, data can be collected over time to check if mean/standard deviations are within limits defined by the SLA.

The composite latency may then be traded-off with different cost computation models across SLA/IoT tiers as illustrated in Table 3 where C is the QoS composite metric.

TABLE 3
Cost Composition for IoT:

| | | Transformed | |
|---|---|---|---|
| | Atomic SLA | SLA in units of | |
| | value/service | uniformed | |
| SLA Tier | value | language values | SLA Composition |
| IoT Sensor s1 | Cost C dependent | C(s1) = C * λ(s1) | C(s1) |
| | on sensing rate | | |
| | λ(s1) | | |
| UE to BS network | Slice cost C, which | C(s2) | C(s1) ⊕ C(s2) |
| slice s2 | is typically | | |
| | constant | | |
| BS to edge/cloud | Slice cost C, which | C(s3) | C(s1) ⊕ C(s2) ⊕ |
| network slice s3 | is typically | | C(s3) |
| | constant | | |
| Edge compute | Compute node | ∨C {cpu, memory, | C(s1) ⊕ C(s2) ⊕ |
| Node s4 | tiers, with cost | disk, VM} | C(s3) ⊕ C(s4) |
| | associated for each | | |
| | tier/elastic | | |
| | compute node | | |
| (Redundant) | Compute node | ∨C {cpu, memory, | C(s1) ⊕ C(s2) ⊕ |
| Cloud Compute | tiers, with cost | disk, VM} | C(s3) ⊕ ∧ (C(s4) |
| Node s5 | associated for each | | ⊕ C(s5)) |
| | tier/elastic | | |
| | compute node | | |
| IoT Actuator s6 | Cost C, which may | C(s6) | C(s1) ⊕ C(s2) ⊕ |
| | be invocation | | C(s3) ⊕ ∧ (C(s4) |
| | based/flat rate | | ⊕ C(s5)) ⊕ C(s6) |

Note that the end to end cost can be provided to customers in different forms: slab rate, per invocation, summation of current costs, etc. Customer specifies some cost - minimize/optimize selection of SLAs to be profitable.

Network Slicing KPI Embodiment

In one or more embodiments, the network slice key performance indicators (KPIs) may also be composed in the QoS/SLA model:
1) Upstream throughput for Network and Network Slice Instance: This KPI describes the upstream throughput λ_{uplink-slice} of one single network slice instance by computing the packet size for each successfully transmitted Uplink (UL) IP packet through the network slice instance during each observing granularity period.
2) Downlink Throughput for Single Network Slice Instance: This KPI describes the downstream throughput) λ_{downlink-slice} of one single network slice instance by computing the packet size for each successfully transmitted downlink (DL) internet protocol (IP) packet through the network slice instance during each observing/monitoring granularity period and is used to evaluate integrity performance of the end-to-end network slice instance.
3) Mean number of protocol data unit (PDU) sessions of network and network slice instance: This KPI describes the mean number of PDU sessions that are successfully established in a network slice instance and obtained by successful PDU session establishment procedures of SMFs which is related to the network slice instance. The number of sessions may be linked to latency and throughput, for instance, via Little's law.
4) Virtualized Resource Utilization of Network Slice Instance: This KPI describes the utilization of virtualized resource (e.g., processor, memory, disk) divided by the system capacity that is allocated to the network slice instance. It can be modeled via the availability α QoS metric.

The end-to-end latency δ may be a performance parameter for operating a 5G network. In some scenarios (e.g., ultra-reliable low-latency communication (uRLLC)), if end-to-end latency is insufficient, the 5G network customer associated with a wireless device 22 may not be able to obtain guaranteed network performance provided by the network operator/service provider. A number of registered subscribers (N) of a single network slice instance can be used to describe the amount of subscribers/wireless devices 22 that are successfully registered, which may reflect/corresponds to the usage of network slice instance.

SLA on throughput provided per network slice (data transmitted within a given time limit) is calculated, the deviation from the desired/predefined KPI specified in SLA composition may be used in contingent planning.

Therefore, a model has been described that may allow for QoS composition of web services to be extended to services of IoT. A next step is to automate composition of the end-to-end SLA via efficient planning.

Planning for SLA Composition

Contingent Planning Transformation of IoT SLAB

One or more rules are provided to map individual atomic service QoS that are composed using contingent/metric (e.g., latency, cost) based AI planning systems. For example, the algorithm may be as follows:

| | |
|---|---|
| (:types | service |
| | pattern |

```
  )
  (:functions (QoS_value ?pattern ?domain)
```

(SLA))

(:constants true false latency cost)

| | |
|---|---|
| (:predicates | (available ?s - service) |
| | (bound ?s - service) |
| | ) |

```
(:durative-action series-compose
    :parameters (?s1 - service ?s2 - service ?pattern - pattern)
    :duration (= ?duration 1)
    :condition (and (at start (available ?s1)) (at start (available ?s2)) )
    :effect (and (at end (bound ?s1)) (at end (bound ?s2)) (at end(increase
(SLA) (QoS_value ?pattern latency))) ))
  (:durative-action parallel-compose
    :parameters (?s1 - service ?s2 - service ?pattern - pattern)
    :duration (= ?duration 1)
    :condition (and (at start (available ?s1)) (at start (available ?s2)) )
    :effect (and (at end (bound ?s1)) (at end (bound ?s2)) (at end(increase
(SLA) (QoS_value ?pattern cost))) ))
```

The algorithm advantageous allows for dynamic reconfiguration with variations in SLAs, changes in ordering of end-to-end SLAs. For example, new services can be dynamically composed/included in this model, for instance, incorporating newer services/alternate composition models.

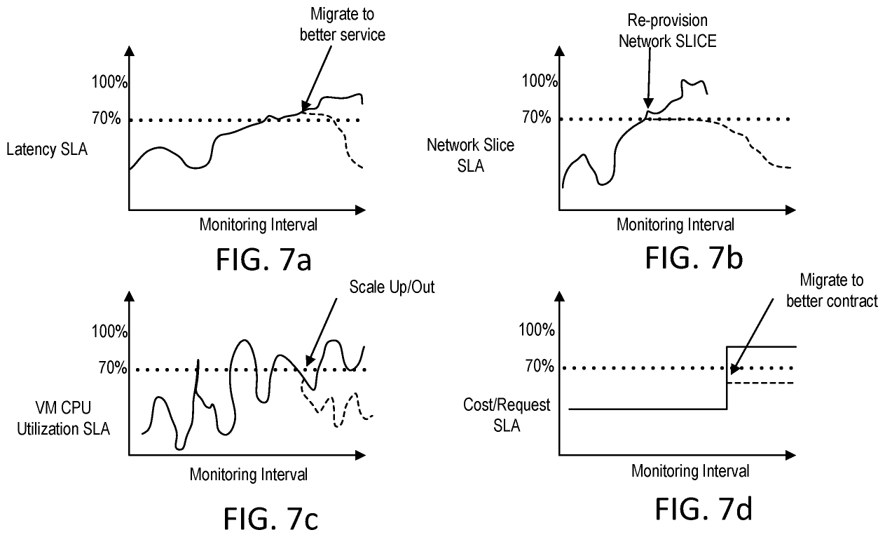

FIGS. 7a-7d are graphs of a few different examples of contingent planning outputs that may be used to generate and/or manage composite SLAs due to deviations. Optimizations with metrics may also be included in the plan outputs.

Migration Due to Latency Deviation (Better Service)

Migrate from SLA1 to SLA2 due to deviation in latency:

ff: found plan as follows

-------------------------------------------------
0∥0 --- SENSEC service1 SLA1 latency_70 --- TRUESON: 1∥0 ---
FALSESON: 1∥1
-------------------------------------------------
1∥0 --- MONITOR service1 SLA1 --- SON: 2∥0
1∥1 --- SENSEC service1 SLA2 latency_70 --- TRUESON: 2∥1 ---
FALSESON: 2∥2
-------------------------------------------------
2∥1 --- MONITOR service1 SLA1 --- SON: 3∥1
2∥2 --- MIGRATE service2 SLA2 --- SON: 3∥2
-------------------------------------------------

Reconfiguration Due to Network Deterioration (Improve Slice)

Allocating a larger slice due to sensed network deterioration:

ff: found plan as follows

-------------------------------------------------
0∥0 --- SENSEC network SLA1 network_QoE --- TRUESON: 1∥0 ---
FALSESON: 1∥1
-------------------------------------------------
1∥0 --- MONITOR network SLA1 --- SON: 2∥0
1∥1 --- SENSEC network SLA2 network_QoE --- TRUESON: 2∥1 ---
FALSESON: 2∥2
-------------------------------------------------
2∥1 --- MONITOR network SLA1 --- SON: 3∥1
2∥2 --- MIGRATE network SLA2 network_QoE --- SON: 3∥2
-------------------------------------------------

Reconfiguration Due to Resource Utilization Limits (Scale-Up/Out)

Additional scaled up/out resources added:

ff: found plan as follows

-------------------------------------------------
0∥0 --- SENSEC service1 SLA1 cloud VM1 --- TRUESON: 1∥0 ---
FALSESON: 1∥1
-------------------------------------------------
1∥0 --- MONITOR service1 SLA1 --- SON: 2∥0
1∥1 --- SENSEC service1 SLA2 cloud VM2 --- TRUESON: 2∥1 ---
FALSESON: 2∥2
-------------------------------------------------
2∥1 --- MONITOR service1 SLA1 --- SON: 3∥1
2∥2 --- MIGRATE service1 SLA2 cloud_VM2 --- SON: 3∥2
-------------------------------------------------

Migration Due to Business SLA Constraints (Demand Variation)

Migrate from “SLAB RATE” SLA to “per invocation” SLA:

ff: found plan as follows

-------------------------------------------------
0∥0 --- SENSEC service1 SLA1 per_invocation --- TRUESON: 1∥0 ---
FALSESON: 1∥1
-------------------------------------------------
1∥0 --- MONITOR service1 SLA1 --- SON: 2∥0
1∥1 --- SENSEC service1 SLA2 slab_rate --- TRUESON: 2∥1 ---
FALSESON: 2∥2
-------------------------------------------------
2∥1 --- MONITOR service1 SLA1 --- SON: 3∥1
2∥2 --- MIGRATE service2 SLA1 per_invocation --- SON: 3∥2
-------------------------------------------------

### SLA Monitoring and Enforcement Policy

In the above example, a customer specifies the Service Workflow(S), Budget (Cₘₐₓ), and Maximum permissible latency (δₘₐₓ) to node 24, i.e., the AI Planner. The customer can also specify a threshold parameter and time-slice for the monitoring agent and a priority order of constraints/parameters for the node 24, i.e., AI Planner. Alternatively one or more of these parameters may pre-configured. One or more purposes of these parameters may be to:
1. Make node 24 that performs the planning functionality described herein more robust by prioritizing one constraint over another such as in Mission Critical customer service.
2. Support more practical Service Workflows, e.g., supporting service deployments where only 90% of the time the latency constraints need to be satisfied.
3. Time-slice value allows to parameterize the reactivity of the node 24, i.e., AI Planner. For example, a smaller time-slice may provide a more-reactive approach.

In this example, the threshold is δ_{Threshold} and the latency constraint is prioritized over the budget (i.e., cost) constraint. Based on these inputs, node 24, i.e., AI Planner, may perform following operations:
1. Identify the class of individual “atomic services” sᵢ that are needed for the deployment of customer Service Workflow ‘5’, i.e., end-to-end SLA. At each individual level (e.g., sensors/actuators, wireless device 22 to network node 16 network, network node 16 to edge network, edge Compute, and cloud) there could be multiple alternatives for these atomic services provided by different vendors. Further, each of these services offer different QoS and Cost associated with them.
2. Based on the maximum latency bound (δₘₐₓ), node 24 may then select atomic services out of these previously identified atomic services at each level, i.e., IoT level, within the customer Budget (Cₘₐₓ).
3. Deploy and chain these services together to compose the overall customer Service Workflow(S), i.e., compose the end-to-end SLA and composite SLA.
4. A monitoring agent may keep track of the number of SLA violations for the user/wireless device 22 requests, i.e., monitor operation data. In this case, the monitoring may indicate the number of requests where the user/wireless device 22 requests took more than δₘₐₓ time, i.e., δ>δₘₐₓ, i.e., a predefined criterion associated with predefined quantity of instances is not met. This monitoring may be performed for a time-slice.
5. This monitoring agent can choose to invoke/trigger the planning functionality of node 24 for enforcing the SLA based on the predefined threshold percentage (δ_{Threshold}) that may be specified by the user.
6. Once the planning functionality of node 24 is invoked/triggered, node 24 may try to again to identify the alternative available atomic services that can meet the δₘₐₓ latency bound/limit/threshold. The process may perform the actions of step 3. That is, a second end-to-end composite SLA may be generated where the second end-to-end composite SLA is different from the end-to-end composite SLA in step 3.
7. The situation may occur where there is no such possible set of atomic services that can be composed to deploy Service Workflow(S), i.e., no end-to-end composite SLA can be generated that meets the criteria of δₘₐₓ within Cₘₐₓ. In this situation, node 24 may determine to relax one or more of the limitations. For example, node 24 may relax the budget limitation in case the latency constraint is of higher priority by selecting the atomic services for which the δₘₐₓ bound is met while the cost may be greater than Cₘₐₓ but is the minimum of available cost, i.e., another end-to-end composite SLA may be generated. Thereafter, in one or more embodiments, after every time-slice, node 24 may be invoked/triggered by the monitoring agent even if the number of SLA violation (δ>δₘₐₓ) is less than threshold limit. In other words, node 24 may look for the availability of atomic service that may satisfy the budget constraint (Cₘₐₓ) and the latency constraint (δₘₐₓ).

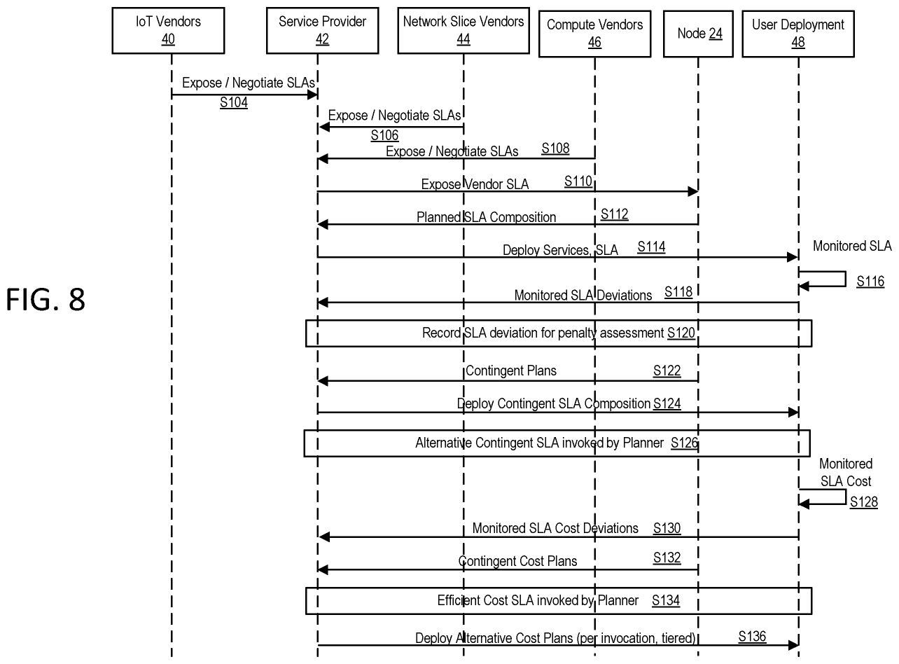

FIG. 8 is a sequence diagram demonstrating the composition of the SLAs with contingencies due to SLA deviations and contingent cost plans according to principles of the disclosure. Note that the initial sequence is similar to what web services SLAs are created, but the planning and composition is modified based on outputs of node 24. While traditional SLAs would record deviations from the constraints and penalize vendors monetarily, the model described herein is advantageously able to implement contingent SLAs and/or alternate cost structures as well, thereby dynamically modifying and/or changing the end-to-end composite SLA.

IoT vendors 40 expose/inform and/or negotiate SLAs with service provider 42 (Block S104). Network slice vendors 44 expose/inform and/or negotiate SLAs with the service provider 42 (Block S106). Compute vendors 46 expose/inform and/or negotiate SLAs with the service provider (Block S108). Service provider 42 exposes/informs node 24 of the various vendor SLAs such as those SLAs referred to in Blocks S104-S108 (Block S110).

Node 24 is configured to communicate the planned SLA composition to the service provider 42 (Block S112). Service provider deploys services according to the planned SLA composition (Block S114). User deployment 48 is configured to monitor the deployed services associated with the SLA (Block S116). User deployment 48 is configured to communicate monitored SLA deviations to service provider 42 (Block S118). Service provider 42 is configured to record the SLA deviation for penalty assessment (Block S120).

Node 24 is configured to communicate the contingent plans to the service provider 42 (Block S122). Service provider is configured to cause deployment of the contingent SLA composition (Block S124). The alternative contingent SLA is invoked by node 24 (Block S126).

User deployment 48 is configured to monitor SLA cost (Block S128). User deployment is configured to communicate monitored SLA cost deviations with respect to the contingent SLA to the service provider 42 (Block S130). Node 24 is configured to communicate the contingent cost plans to the service provider 42 (Block S132). Node 24 is configured to invoke/trigger an efficient cost SLA (Block S134). Service provider 42 is configured to cause the contingent cost plans (per invocation, tiered) to be deployed (Block S146).

In one or more embodiments, one or more business models may be included within the SLA optimization process. For example, the business model may be a per-invocation, tiered, demand driven contract composition with multiple tier where the business model may indicate which layer hardware/data/monitor the vendor (e.g., network slice vendor 44 or 46) uses for which service. Business plans (per invocation, slabs, demand driven) may be applicable for various IoT application types. However, rather than renegotiate for price/payments, renegotiate for another provider dynamically, one or more embodiments described herein is able to dynamically determine, modify and/or change the business model. In particular, the business models is extended across all IoT tiers/layers where node 24 is configured to perform an optimized planning mechanism to determine the business model that may be employed.

Table 4 illustrates the mapping of QoS requirements with SLA models.

TABLE 4

| | Measurements/ | |
|---|---|---|
| Tier | Guarantees | SLA Model |
| IoT Sensor | Sensing timelines, | Invocation/second traded off |
| Actuator | actuation time, | with slab/invocation/flat rate |
| | availability, accuracy | cost |
| Edge/Cloud | CPU/Memory resources | Resources and scale traded off |
| Compute | on VMs, scaling up-out | with slab/invocation/flat rate |
| | accuracy, availability | cost |
| Network | QoE specific network | QoE traded off with |
| | slicing and software | slab/invocation/flat rate cost |
| | defined provisioning | |
| Customer | Number of violations, | Dynamically reconfiguring |
| Contract | deteriorations | vendors above, optimizing |
| | | slab/invocation/flat rate cost |

One or more embodiments described herein provide an optimization over business models. Further, if there is a price deviation from changing the vendor sub-contract associated with an SLA to slab rate from per-invocation rate (demand change), this migration advantageously happens seamlessly depending on demand. The price arbitration helps optimize the cost of sub-contracting the component SLA such as via the customer exposed contract.

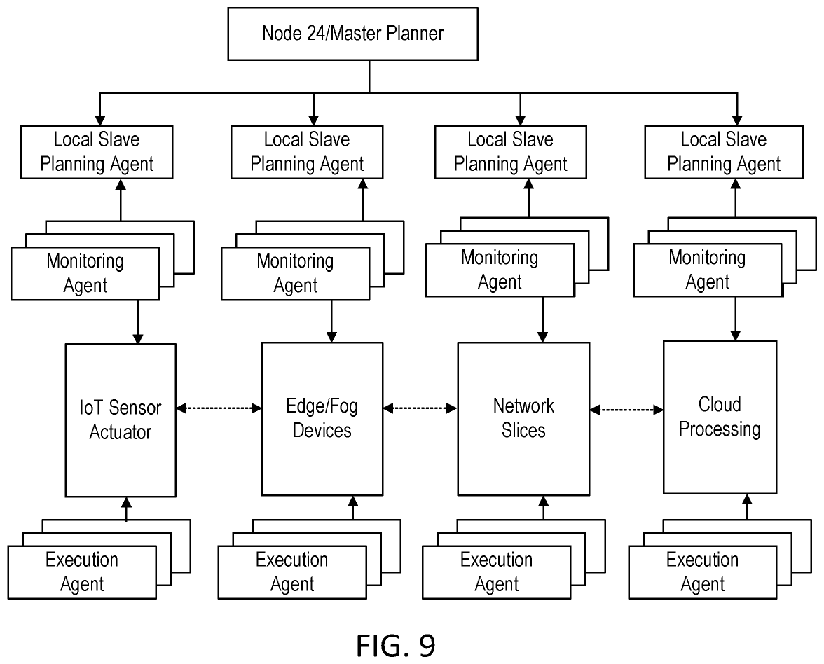

FIG. 9 is an example of a cloud, i.e., distributed, implementation according to the principles of the disclosure. In particular, while the SLA composition and reconfiguration process includes distributed IoT, edge, cloud and network slicing resources, techniques may be extended to include the following distributed processing:
Distributed monitoring: monitoring agents deployed throughout the IoT network can distribute areas of interest to be monitored.
Network slice processing: Generating the individual slices for each SLA requirement is a computationally intensive task—this can be performed on the cloud or over distributed resources on the edge of the network such as by an edge node 24.
Hierarchical planning—Rather than solving a complex contingent planning problem with a central planner such as node 24, this contingent planning may be divided into master/local slave planning agents. This may distribute the plan processing and evaluation across multiple devices. Algorithms for intelligent plan partitioning, providing efficient “local” sub-goals and monitoring local slave planning agent may be implemented.
Execution of tasks is decentralized (sensing/actuating) and performed by execution agent with decision making on SLA re-configuration relying on the node 24.

IoT SLA Model

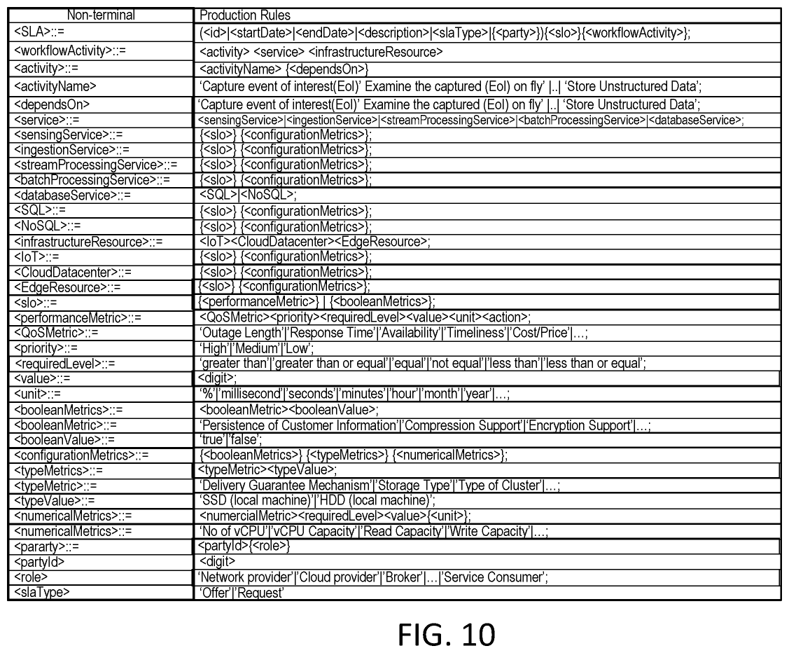

As there are counters from different tiers/layers that may require monitoring for SLA deviation/contract composition, these counters may need to be accurately monitored. Such monitoring may include monitoring/orchestration of compute/network/service/data components. Further, dynamic update/deletion of sub-contracts may be needed based on these monitored counters. FIG. 10 illustrates examples of parameters that may be monitored.

Automated maintenance of SLA contracts may be performed using the ADULA framework. The processes may be monitored and a transparent view of the reconfiguration is provided. The utility of dynamic adaptation of SLA vendors with minimal overhead is demonstrated herein.

SLA Composition Model

The Web Service Level Agreement (WSLA) protocol may be used as the baseline comparison for the model described herein. WSLA consists of the following stages:
1. Stage 1: SLA Negotiation and Establishment.
2. Stage 2: SLA Deployment
3. Stage 3: Service Level Measurement and Reporting.
   a. Measurement Service.
   b. Condition Evaluation Service.
4. Stage 4: Corrective Management Actions
5. Stage 5: SLA Termination.

The WSLA language uses the tuple of Service Level Objectives (SLO) and Action Guarantees.

Business Pricing Models

There are a number of pricing models provided by vendors upon which QoS metrics may be determined:
Lambda counts a request each time it starts executing in response to an event notification or invoke call, including test invokes from the console.
The models for AWS lambda are:
   Free Tier—1 million requests per month;
   Requests—Free 1 million requests, 0.2/million request thereafter;
   Duration—400,000 GB-seconds per month free.
Cloud Functions are priced according to how long the function runs, how many times the function is invoked and how many resources are provisioned for the function. Here are the pricing options per feature:
   Invocations: Function invocations are charged at a flat rate, independent of the source of the invocation;
   Compute Time: Compute time is measured from the time the function receives a request to the time it completes, either through the function signaling completion, or through a timeout;
   Networking: Outbound data transfer (that is, data transferred from the function out to somewhere else) is measured in GB and charged at a flat rate.

Therefore, one or more embodiments described herein advantageously exploits uniform modeling, composition and artificial intelligence (AI) based composition of IoT service QoS. The SLA modeling is also enhanced to a granular, time-limited, sub-contractable form that may be dynamically composed. Such a structured format for SLA composition is useful in multi-vendor IoT scenarios where sensor/actuators, computation, network and business functionalities are externalized and located on various IoT layers.

Table 5 contrasts an existing approach with one or more embodiments (composition approach) in accordance with the principles of the disclosure that are described herein.

TABLE 5

| IoT SLA | | |
|---|---|---|
| Features | Existing Approach | Composition Approach |
| SLA | Static SLA composition | Dynamic SLA |
| composition | with pre-specified vendor | composition based on |
| | contracts. | planning and re- |
| | | configuration. QoS |
| | | algebra encoded within |
| | | the planning model to |
| | | allow for composition |
| IoT SLA | Typically sensors, | Transforms SLA at |
| Transformation | actuators treated as best | different tiers (IoT, |
| | effort with contracts for | edge/cloud compute, |
| | compute/networking | network slicing, etc.) into |
| | nodes. | a unified format for |
| | | processing. |
| SLA | Contract violation | Due to the contingent |
| Reconfiguration | typically involves | planning process in this |
| | monetary payment. | approach, contract |
| | | violations result in new |
| | | SLA contracts to |
| | | alternate vendors. SLA |
| | | timelines monitored. |

Therefore, the composition approach described herein allows for automated composition of SLA contracts, i.e., automated end-to-end composite SLA generation and/or modification, for IoT devices using AI planning, contingent planning processes.

As will be appreciated by one of skill in the art, the concepts described herein may be embodied as a method, data processing system, computer program product and/or computer storage media storing an executable computer program. Accordingly, the concepts described herein may take the form of an entirely hardware embodiment, an entirely software embodiment or an embodiment combining software and hardware aspects all generally referred to herein as a “circuit” or “module.” Any process, step, action and/or functionality described herein may be performed by, and/or associated to, a corresponding module, which may be implemented in software and/or firmware and/or hardware. Furthermore, the disclosure may take the form of a computer program product on a tangible computer usable storage medium having computer program code embodied in the medium that can be executed by a computer. Any suitable tangible computer readable medium may be utilized including hard disks, CD-ROMs, electronic storage devices, optical storage devices, or magnetic storage devices.

Some embodiments are described herein with reference to flowchart illustrations and/or block diagrams of methods, systems and computer program products. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer (to thereby create a special purpose computer), special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable memory or storage medium that can direct a computer or other programmable data processing apparatus to function in a particular manner, such that the instructions stored in the computer readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

It is to be understood that the functions/acts noted in the blocks may occur out of the order noted in the operational illustrations. For example, two blocks shown in succession may in fact be executed substantially concurrently or the blocks may sometimes be executed in the reverse order, depending upon the functionality/acts involved. Although some of the diagrams include arrows on communication paths to show a primary direction of communication, it is to be understood that communication may occur in the opposite direction to the depicted arrows.

Computer program code for carrying out operations of the concepts described herein may be written in an object oriented programming language such as Java® or C++. However, the computer program code for carrying out operations of the disclosure may also be written in conventional procedural programming languages, such as the “C” programming language. The program code may execute entirely on the user's computer, partly on the user's computer, as a stand-alone software package, partly on the user's computer and partly on a remote computer or entirely on the remote computer. In the latter scenario, the remote computer may be connected to the user's computer through a local area network (LAN) or a wide area network (WAN), or the connection may be made to an external computer (for example, through the Internet using an Internet Service Provider).

Many different embodiments have been disclosed herein, in connection with the above description and the drawings. It will be understood that it would be unduly repetitious and obfuscating to literally describe and illustrate every combination and subcombination of these embodiments. Accordingly, all embodiments can be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

It will be appreciated by persons skilled in the art that the embodiments described herein are not limited to what has been particularly shown and described herein above. In addition, unless mention was made above to the contrary, it should be noted that all of the accompanying drawings are not to scale. A variety of modifications and variations are possible in light of the above teachings without departing from the scope of the following claims.

1. A node configured to:
transform a plurality of service level agreement, SLA, values into a plurality of uniform language values associated with at least a first quality of service, QoS, composite metric; and
generate a first end-to-end composite SLA based at least on a first set of the plurality of uniform language values.

2. The node of claim 1, further configured to receive at least one predefined criterion including a maximum first QoS composite metric value, the generating of the first end-to-end composite SLA being based on the maximum first QoS composite metric value.

3. The node of claim 2, further configured to:
monitor operational data associated with the first end-to-end composite SLA;
determine that the operational data fails to meet the at least one predefined criterion in a predefined quantity of instances; and
generate a second end-to-end composite SLA based at least on the determination that the operational data fails to meet the at least one predefined criterion in the predefined quantity of instances, the second end-to-end composite SLA being based at least on a second set of the plurality of uniform language values.

4. The node of claim 2, wherein the plurality of uniform language values are associated with a second QoS composite metric that is different from the first QoS composite metric; and
one of:
the first QoS composite metric is prioritized over the second QoS composite metric for generating an end-to-end composite SLA; and
the second QoS composite metric is prioritized over the first QoS composite metric for generating an end-to-end composite SLA.

5. The node of claim 4, wherein the second QoS composite metric is a cost metric.

6. The node of claim 4, wherein the at least one predefined criterion includes a maximum second QoS composite metric value, the generating of the first end-to-end SLA being based on the maximum second QoS composite metric value of the at least one predefined criterion.

7. The node of claim 2, further configured to:
monitor operational data associated with the first end-to-end composite SLA;
determine the operational data fails to meet the at least one predefined criterion in a predefined quantity of instances; and
generate a second end-to-end composite SLA based at least on the determination that the operational data fails to meet the at least one predefined criterion in the predefined quantity of instances, the second end-to-end composite SLA being based at least on the second set of the plurality of uniform language values.

8. The node of claim 7, wherein the second end-to-end composite SLA is associated with at least one different service vendor than the first end-to-end composite SLA.

9. The node of claim 7, wherein the second end-to-end composite SLA corresponds to a plurality of predefined SLAs, each predefined SLA configured to provide a network service according to a respective service value.

10. The node of claim 7, wherein the second end-to-end composite SLA is configured to provide one of:
less latency deviation than the first end-to-end composite SLA;
a larger network slice than the first end-to-end composite SLA; and
addition network resources than the first end-to-end composite SLA.

11. The node of claim 7, wherein one of:
the second set of the plurality of uniform language values meets the at least one predefined criterion; and
the second set of the plurality of uniform language values meets a modified version of the at least one predefined criterion, the modified version of the at least one predefined criterion being configured due to the plurality of uniform language values being unable to meet the at least one predefined criterion.

12. The node of claim 2, wherein the at least one predefined criterion is provided by a user of the first end-to-end composite SLA.

13. The node claim 1, further configured to:
identify a plurality of SLA tiers, each SLA tier including at least one of the plurality of SLA values; and
the generating of the first end-to-end composite SLA being based on selecting uniform language values corresponding to each one of the plurality of SLA tiers to form the first set of the plurality of uniform language values.

14. The node of claim 13, wherein the plurality of SLA tiers include one of a first tier associated with a network slice from a wireless device to a network node, a second tier associated with a network slice from the network node to an edge network node, and a third tier associated with a cloud network computing network node.

15. A method implemented by a node, the method comprising:
transforming a plurality of service level agreement, SLA, values into a plurality of uniform language values associated with at least a first quality of service, QoS, composite metric; and
generating a first end-to-end composite SLA based at least on a first set of the plurality of uniform language values.

16. The method of claim 15, further comprising receiving at least one predefined criterion including a maximum first QoS composite metric value, the generating of the first end-to-end composite SLA being based on the maximum first QoS composite metric value.

17. The method of claim 16, further comprising:
monitoring operational data associated with the first end-to-end composite SLA;
determining that the operational data fails to meet the at least one predefined criterion in a predefined quantity of instances; and
generating a second end-to-end composite SLA based at least on the determination that the operational data fails to meet the at least one predefined criterion in the predefined quantity of instances, the second end-to-end composite SLA being based at least on a second set of the plurality of uniform language values.

18. The method of claim 16, wherein the plurality of uniform language values are associated with a second QoS composite metric that is different from the first QoS composite metric; and
one of:
the first QoS composite metric is prioritized over the second QoS composite metric for generating an end-to-end composite SLA; and
the second QoS composite metric is prioritized over the first QoS composite metric for generating an end-to-end composite SLA.

19. The method of claim 18 wherein the second QoS composite metric is a cost metric.

20. The method of claim 18, wherein the at least one predefined criterion includes a maximum second QoS composite metric value, the generating of the first end-to-end SLA being based on the maximum second QoS composite metric value of the at least one predefined criterion.

21. The method of claim 16, further comprising:
monitoring operational data associated with the first end-to-end composite SLA;
determining the operational data fails to meet the at least one predefined criterion in a predefined quantity of instances; and
generating a second end-to-end composite SLA based at least on the determination that the operational data fails to meet the at least one predefined criterion in the predefined quantity of instances, the second end-to-end composite SLA being based at least on the second set of the plurality of uniform language values.

22. The method of claim 21, wherein the second end-to-end composite SLA is associated with at least one different service vendor than the first end-to-end composite SLA.

23. The method of claim 21, wherein the second end-to-end composite SLA corresponds to a plurality of predefined SLAs, each predefined SLA configured to provide a network service according to a respective service value.

24. The method of claim 21, wherein the second end-to-end composite SLA is configured to provide one of:
less latency deviation than the first end-to-end composite SLA;
a larger network slice than the first end-to-end composite SLA; and
addition network resources than the first end-to-end composite SLA.

25. The method of claim 21, wherein one of:
the second set of the plurality of uniform language values meets the at least one predefined criterion; and
the second set of the plurality of uniform language values meets a modified version of the at least one predefined criterion, the modified version of the at least one predefined criterion being configured due to the plurality of uniform language values being unable to meet the at least one predefined criterion.

26. The method of claim 16, wherein the at least one predefined criterion is provided by a user of the first end-to-end composite SLA.

27. The method of claim 15, further comprising:
identifying a plurality of SLA tiers, each SLA tier including at least one of the plurality of SLA values; and
the generating of the first end-to-end composite SLA being based on selecting uniform language values corresponding to each one of the plurality of SLA tiers to form the first set of the plurality of uniform language values.

28. The method of claim 27, wherein the plurality of SLA tiers includes one of a first tier associated with a network slice from a wireless device to a network node, a second tier associated with a network slice from the network node to an edge network node, and a third tier associated with a cloud network computing network node.
